(19) United States
(12) Patent Application Publication
(10) Pub. No.: US 2010/0244497 A1
(43) Pub. Date: Sep. 30, 2010

(54) CONNECTION STRUCTURE AND ASSEMBLY METHOD OF TUBE-SHAPED FRAMES

(75) Inventors: Masanori HONDA, Hiroshima (JP); Shin SASAKI, Hiroshima (JP); Takayuki HASHIDA, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/710,045

(22) Filed: Feb. 22, 2010

(30) Foreign Application Priority Data
Mar. 31, 2009 (JP) 2009-086649

(51) Int. Cl. B62D 21/00; B21D 53/88

(52) U.S. Cl. 296/205; 29/897.2

(57) ABSTRACT

A first split-bracket is joined to a first tube-shaped frame by lazar welding. A second split-bracket is joined to an end portion of a second tube-shaped frame by the lazar wielding. The second tube-shaped frame equipped with the second split-bracket is assembled to the first tube-shaped frame equipped with the first split-bracket. A second flange of the first split-bracket and a second flange of the second split-bracket are joined temporarily by spot welding. The second flange of the first split-bracket and the second flange of the second split-bracket are joined by continuous welding with lazar welding. Accordingly, the tube-shaped frames can be connected properly without forming any hole at a wall of the tube-shaped frame, ensuring the rigidity of the connection portion of the tube-shaped frames.

### BACKGROUND OF THE INVENTION

The present invention relates to a connection structure and assembly method of tube-shaped frames.

The use of a tube-shaped frame has been developed to improve the rigidity of a vehicle body or others despite a relatively small area of a closed cross section of the tube-shaped frame.

Japanese Patent Laid-Open Publication No. 62-173378 discloses the structure in which the front pillar is comprised of the outer panel and the tube-shaped frame, and the outer pillar has the flange which is equipped with the door seal strip. This tube-shaped frame is comprised of the tube which is made by the hydro-forming and has the substantially hexagonal cross section, and the base portion of the outer panel is joined to the flat front face portion of the tube-shaped frame so that the windshield is supported at the base portion of the outer panel.

Japanese Patent Laid-Open Publication No. 2006-182079 discloses the proposal in that the hollow member with the closed cross section is made by the hydro-forming, and the outer panel is attached to the outside of this hollow member to form the front pillar.

Japanese Patent Laid-Open Publication No. 2002-145117 discloses the proposal in that the roof frame of a vehicle, which comprises the right and left front pillars, the right and left roof sides and the rear header, is made of the reinforcement members which are formed of the pipe-shaped high tension steel plates through the hydro-forming

Japanese Patent Laid-Open Publication No. 2002-120754 discloses the structure which can improve bending rigidity or tensional rigidity of a vehicle frame by using split flanges.

In these days, the vehicle-body structure is generally designed by using a so-called “monocoque” method. The inventors of the present patent application have developed the vehicle-body structure using the above-described tube-shaped frame. In case of the tube-shaped frame structure, it may be necessary to develop the structure in which the tube-shaped frames can be properly connected ensuring the rigidity of the tube-shaped frames. That is, the spot welding, which is generally used for the monocoque body, requires a couple of electrodes to be located on both sides of a welding article. Herein, in case the spot welding is applied to the tube-shaped frame structure, a through hole may need to be formed at the tube-shaped frame so that one of the electrodes could be inserted into the inside of the tube-shaped frame through this hole. However, this though hole formed may decrease the rigidity of the tube-shaped frame improperly.

### SUMMARY OF THE INVENTION

Accordingly, an object of the present invention is to provide a connection structure of tube-shaped frames in which the tube-shaped frames can be connected properly without forming any hole at the wall of the tube-shaped frame.

Another object of the present invention is to provide the connection structure of tube-shaped frames which can ensure the rigidity of the connection portion of the tube-shaped frames.

Further, another object of the present invention is to provide an assembly method of tube-shaped frames in which the tube-shaped frames can be assembled properly.

According to an aspect of the present invention, there is provided a connection structure of tube-shaped frames, comprising plural tube-shaped frames, and plural split-brackets provided at a connection portion of the plural tube-shaped frames, each of the split-brackets having a shape for receiving part of the plural tube-shaped frames at the connection portion, wherein the split-brackets are joined to each other at facing portions thereof by continuous welding, and each of the split-brackets is joined to one of the tube-shaped frames which is located adjacent thereto by one-side continuous welding.

According to this aspect of the present invention, the tube-shaped frames can be connected properly without forming any hole at the wall of the tube-shaped frame, ensuring the rigidity of the connection portion of the tube-shaped frames. Further, since the plural tube-shaped frames are connected via the brackets, the gap between the tube-shaped frames can be properly controlled.

According to an embodiment of the present invention, each of the split-brackets has a flange which extends outwardly along a split line of the facing portions of the split-brackets, and the flanges of the split-brackets which are overlapped are joined to each other by one-side continuous welding. Thereby, since the flanges of the split-brackets are overlapped via contact faces, even if some gap occurs between the tube-shaped frames, the gap can be properly controlled by adjusting overlapping of the flanges.

According to another embodiment of the present invention, the brackets comprise an upper split-bracket and a lower split-bracket, each of the upper split-bracket and the lower split-bracket has a flange which extends along a split line of the facing portions of the upper and lower split-brackets, and the flanges of the upper and lower split-brackets which are overlapped are joined to each other by one-side continuous welding. Thereby, the upper and lower split-brackets can be assembled by making the upper split-bracket approach to the lower split-bracket from above. Further, the gap between the tube-shaped frames can be properly controlled by adjusting positioning of the upper and lower split-brackets.

According to another aspect of the present invention, there is provided an assembly method of tube-shaped frames, in which the tube-shaped frames comprise a pair of roof side frames which are provided at both sides of a vehicle body and a roof cross member which extends perpendicularly to the roof side frames so as to connect to the roof side frames at both ends thereof, the assembly method comprising a step of providing brackets for connecting the both ends of the roof cross member to the roof side frames, the brackets comprising an upper split-bracket and a lower split-bracket, each of the upper split-bracket and the lower split-bracket having a flange which extends along a split line of the upper and lower split-brackets, a first step of joining the lower split-bracket to a lower portion of the roof side frame by one-side continuous welding, a second step of joining the upper split-bracket to an upper portion of the end of the roof cross member by one-side continuous welding, a third step of assembling the upper split-bracket joined to the roof cross member to the lower split-bracket joined to the roof side frame, a third step of joining the flanges of the upper and lower split-brackets which are overlapped by temporary welding, and a fifth step of joining the flanges joined by the temporary welding by one-side continuous welding.

According to this aspect of the present invention, the tube-shaped frames can be assembled properly.

Other features, aspects, and advantages of the present invention will become apparent from the following description which refers to the accompanying drawings.

### BRIEF DESCRIPTION OF THE DRAWINGS

FIG. 1 is an exploded perspective view of a connection structure of two tube-shaped frames which are connected in a T shape according to a first embodiment.

FIG. 2 is a plan view of a T-shaped connection portion of FIG. 1.

FIG. 3 is an explanatory diagram showing a making method of the tube-shaped frame.

FIG. 4 is a sectional view of the tube-shaped frame which is made by the making method shown in FIG. 3.

FIG. 5 is a sectional view of a modification of the tube-shaped frame of FIG. 4.

FIG. 6 is a sectional view of another modification of the tube-shaped frame of FIG. 4.

FIG. 7 is a sectional view of a tube-shaped frame which is made of two members having a U-shaped cross section.

FIG. 8 is a sectional view of a modification of the tube-shaped frame of FIG. 4.

FIG. 9 is a plan view of a modification of the connection structure of FIGS. 1 and 2.

FIG. 10 is a perspective view of the connection structure of FIG. 9.

FIG. 11 is an exploded perspective view of the connection structure of FIG. 9.

FIG. 12 is a plan view of a connection structure according to a second embodiment.

FIG. 13 is a perspective view of the second embodiment shown in FIG. 12.

FIG. 14 is an exploded perspective view of the second embodiment shown in FIG. 12.

FIG. 15 is a plan view of a connection structure according to a third embodiment.

FIG. 16 is a perspective view of the third embodiment shown in FIG. 15.

FIG. 17 is a perspective view of the third embodiment, when viewed in a different direction from FIG. 16.

FIG. 18 is an exploded perspective view of the third embodiment shown in FIG. 15.

FIG. 19 is an exploded perspective view of a modification of the third embodiment.

FIG. 20 is an exploded perspective view of another modification of the third embodiment.

FIG. 21 is a perspective view of a connection structure according to a fourth embodiment.

FIG. 22 is an exploded perspective view of the connection structure of the fourth embodiment shown in FIG. 21.

FIG. 23 is an exploded perspective view of the connection structure of the fourth embodiment shown in FIG. 21, when viewed in a different direction from FIG. 22.

FIG. 24 is a view of a connection structure of two tube-shaped frames which are connected in series according to a fifth embodiment.

FIG. 25 is a sectional view taken along line X25-X25 of FIG. 24.

FIG. 26 is an exploded perspective view of the connection structure of the fifth embodiment shown in FIG. 24.

FIG. 27 is an exploded perspective view of a modification of the connection structure of the fifth embodiment shown in FIG. 24.

FIG. 28 is an exploded perspective view of the connection structure shown in FIG. 27.

FIG. 29 is a plan view of a connection structure of two tube-shaped frames which are connected in an L shape according to a sixth embodiment.

FIG. 30 is a perspective view of the connection structure of the sixth embodiment of FIG. 29.

FIG. 31 is a perspective view of the connection structure of the sixth embodiment of FIG. 29, when viewed in a different direction from FIG. 30.

FIG. 32 is an exploded perspective view of the connection structure of the sixth embodiment of FIG. 29.

FIG. 33 is a perspective view of a modification of the connection structure of the sixth embodiment of FIGS. 29 through 32.

FIG. 34 is an exploded perspective view of the modification of the connection structure of the sixth embodiment shown in FIG. 33.

FIG. 35 is an exploded perspective view of the modification of the connection structure of the sixth embodiment shown in FIG. 33, when viewed in a different direction from FIG. 34.

FIG. 36 is a plan view of a connection structure of three tube-shaped frames which are connected in a Y shape according to a seventh embodiment.

FIG. 37 is a perspective view of the connection structure of the seventh embodiment of FIG. 36.

FIG. 38 is an exploded perspective view of the connection structure of the seventh embodiment of FIG. 36.

FIG. 39 is a perspective view of a modification of the connection structure of the seventh embodiment of FIGS. 36 through 38.

FIG. 40 is an exploded perspective view of the connection structure shown in FIG. 39.

FIG. 41 is an exploded perspective view of the connection structure shown in FIG. 39, when viewed in a different direction from FIG. 40.

FIG. 42 is an exploded perspective view of a connection structure of an eighth embodiment.

FIG. 43 is a perspective view of a modification of the connection structure of the eighth embodiment.

FIG. 44 is a perspective view of the connection structure of the eighth embodiment.

FIG. 45 is a perspective view of the connection structure of the eighth embodiment, when viewed in a different direction from FIG. 44.

### DETAILED DESCRIPTION OF THE INVENTION

Hereinafter, preferred embodiments of the present invention will be described referring to the accompanying drawings. Various types of connection structure of tube-shaped frames described below are applicable to various portions of an automotive vehicle. Herein, exemplified portions in this application are as follows:

(i) in case a front pillar, a center pillar and a rear pillar are made of a tube-shaped frame, a connection between respective lower ends of these pillars and a side sill;

(ii) in case right and left side sills are made of a tube-shaped frame, and a cross member which extends in the vehicle width direction between the side sills is made of a tube-shaped frame, a connection between the side sills and the cross member;

(iii) in case right and left front side frames are made of a tube-shaped frame, and a cross member which extends in the vehicle width direction between the front side frames is made of a tube-shaped frame, a connection between the front side frames and the cross member; and

(iv) in case right and left roof side frames, front and rear headers and/or a roof cross member, which extend in the vehicle width direction between the roof side frames, are made of a tube-shaped frame, connections between the roof side frames and the front and rear headers or the roof cross members.

### Embodiment 1

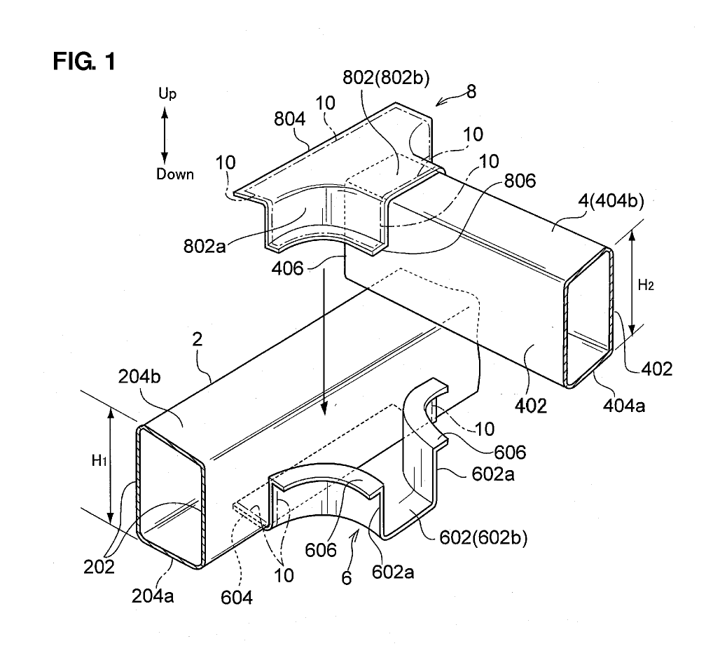

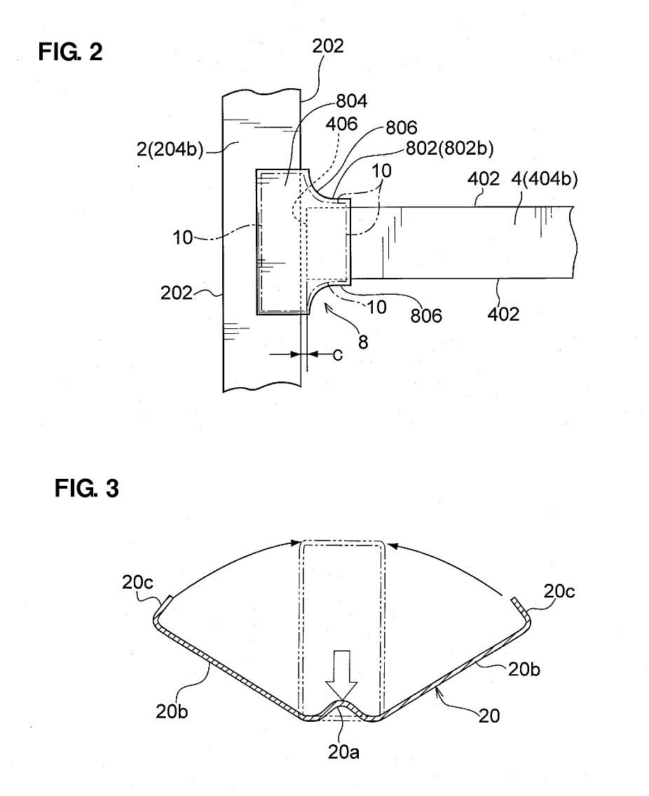

### FIGS. 1 and 2

A first embodiment shows a connection structure in which first and second tube-shaped frames 2, 4 are connected in a T shape. The first and second tube-shaped frames 2, 4 have a structure having a closed rectangular cross section, respectively, which include two side walls 202, 402 which face to each other and end walls 204, 404 which face to each other. Of course, while the first and second tube-shaped frames 2, 4 shown in the figures have a conceptual shape which may be preferable for explanation, any concrete sectional shape may be applicable. Further, the first and second tube-shaped frames 2, 4 shown in the figures have the same height H1, H2 (H1=H2), but they may have different heights.

While the first and second tube-shaped frames 2, 4 are arranged perpendicularly to each other in the example shown in the figures, this crossing angle of these frames 2, 4 is not limited to 90 degrees. The specific connection structure of the first and second tube-shaped frames 2, 4 will be described. The second tube-shaped frame 4 is arranged so that its one-end face 406 butts at the side wall 202 of the first tube-shaped frame 2.

As apparent from FIG. 1, the first and second tube-shaped frames 2, 4 are connected with first and second slit-brackets 6, 8 which are split from each other vertically. The first split-bracket 6 which is located below comprises a bracket body 602 which has a complementary shape for a lower portion of the second tube-shaped frame 4, and a first flange 604 which extends from the bracket body 602 along and on a lower end wall 404a of the first tube-shaped frame 2 for its connection to the first tube-shaped frame 2. More specifically, the bracket body 602 comprises both-side walls 602a, 602a which face to the both-side walls 402, 402 of the second tube-shaped frame 4, and a lower wall 602b which extends between the lower ends of the both-side walls 602a, 602a and faces to a lower end wall 404a of the second tube-shaped frame 4. This lower wall 602b is of a fan shape so as to extend toward the first tube-shaped frame 2. The both-side walls 602a, 602a of the first bracket 6 curve in the plan view so that the distance between the both-side walls 602a, 602a becomes wider gradually toward the first tube-shaped frame 2. At respective upper edges of the side walls 602a are formed second flanges 606 which extend outwardly. These second flanges 606 extends along a split line of the first and second split-brackets 6, 8.

The second split-bracket 8 which is located above has substantially the same shape as the first tube-shaped frame 6. That is, the second split-bracket 8 comprises a bracket body 802 which has a complementary shape for an upper portion of the second tube-shaped frame 4, and a first flange 804 which extends from the bracket body 802 along and on an upper end wall 404b of the first tube-shaped frame 2. More specifically, the bracket body 802 comprises both-side walls 802a, 802a which face to the both-side walls 402, 402 of the second tube-shaped frame 4, and an upper wall 802b which extends between the upper ends of the both-side walls 802a, 802a and faces to an upper end wall 404b of the second tube-shaped frame 4. This upper wall 802b is of the fan shape so as to extend toward the first tube-shaped frame 2. The both-side walls 802a, 802a of the second bracket 8 curve in the plan view so that the distance between the both-side walls 802a, 802a becomes wider gradually toward the first tube-shaped frame 2. At respective lower edges of the side walls 802a are formed second flanges 806 which extend outwardly. Accordingly, the strength of the connection using the first and second split-brackets 6, 8 can be increased.

The first and second tube-shaped frames 2, 4 are connected to each other through the following steps.

[First Step]

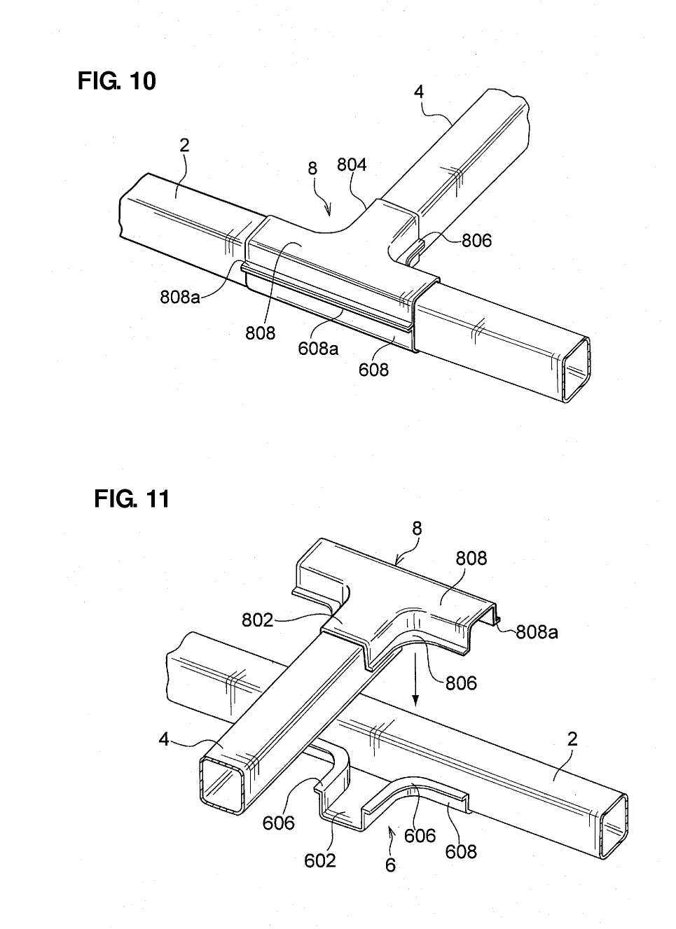

The respective peripheral edges of the first flange 604 and the side walls 602a of the first split-bracket 6 are joined to the lower end wall 204a and the side wall 202 of the first tube-shaped frame 2, respectively, by the one-side continuous welding such as laser welding. The lazar welding portion is shown by a one-dotted broken line in FIG. 10. As apparent from FIG. 1, this lazar welding is applied so as to extend continually along the peripheral edges of the first and second split-brackets 6, 8.

[Second Step]

The peripheral edge of the bracket body 802 of the second split-bracket 8 is joined to the upper end wall 404b and the both-side walls 402 of the end portion of the second tube-shaped frame 4 by the one-side continuous welding, such as the laser welding. Likewise, the lazar welding portion is shown by the one-dotted broken line in FIG. 10.

[Third Step]

The second tube-shaped frame 4 with the second split-bracket 8 is assembled to the first tube-shaped frame 2 with the first split-bracket 6. This assembling is conducted by inserting the end portion of the second tube-shaped frame 4 into the first split-bracket 6 which is joined to the first tube-shaped frame 2 from above. Thus, the second flanges 606, 806 of the first and second split-brackets 6, 8 are overlapped.

[Fourth Step]

The flanges 606, 806 of the first and second split-brackets 6, 8 are joined by temporary spot welding. Herein, this fourth step of temporary joining may be omitted.

[Fifth Step]

The flanges 606, 806 of the first and second split-brackets 6, 8 are joined by one-side continuous welding, such as the lazar welding.

According to the connection structure of the tube-shaped frames 2, 4 using the first and second split-brackets 6, 8, the connection of the first and second tube-shaped frames 2, 4 is possible even if there exits a gap C between the end face 406 of the second tube-shaped frame 4 and the side wall 202 of the first tube-shaped frame 2.

Further, in the conventional assembly line for the monocoque vehicle-body, the above-described temporary joining can be conducted in its spot joining area and then the final joining using the one-side continuous welding, such as the lazar welding, can be conducted. Accordingly, the vehicle body with the tube-shaped frame structure can be manufactured properly.

Herein, the above-described first and second steps may be conducted in a subassembly line or a frame supplier, and the above-described third through fifth steps may be conducted in a body assembly line of an automotive vehicle manufacturing factory after a supply of the first and second tube-shaped frames 2, 4 to which the first and second split-brackets 6, 8 are joined.

While the above-described first and second tube-shaped frames 2, 4 may be comprised of the hollow member disclosed in the above-described second and third publications, a hollow member having a rectangular cross section which is formed by a method shown in FIGS. 3 through 8 may be applied.

The above-described tube-shaped frame structure is applicable to the frame structure of the vehicle roof. In this case, the first tube-shaped frame 2 corresponds to a pair of roof side frames which extend in the vehicle longitudinal direction at right and left end portions of the vehicle roof, and the second tube-shaped frame 4 corresponds to a front or rear header which is arranged at a vehicle front or rear end, or a roof cross member which is arranged at a middle position of the roof.

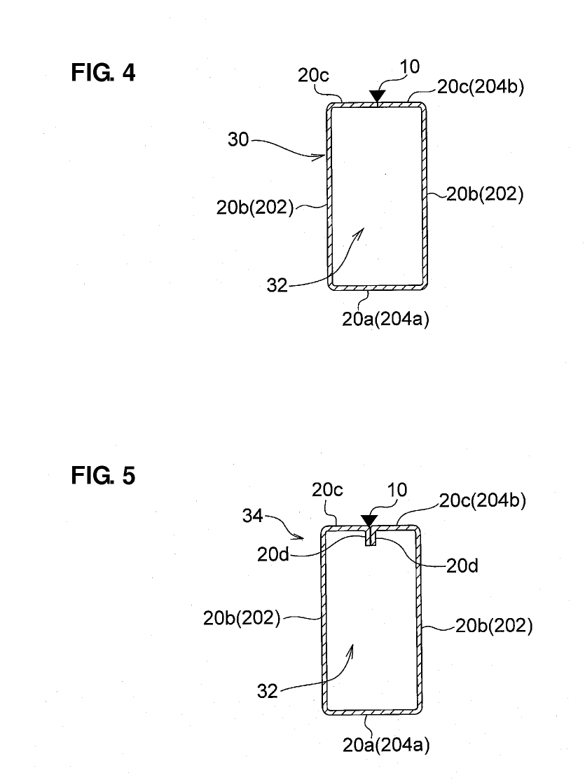

Embodiment of Tube-Shaped Frame (FIGS. 3 and 4)

FIG. 3 shows the tube-shaped frame which is formed by bending a sheet of iron-based metal plate member 20. Specifically, the iron-based metal plate member 20 comprises a middle portion 20a which constitutes the lower end walls 204a, 404a of the first and second tube-shaped frames 2, 4, and this middle portion 20a is formed in a curve shape so as to project upward. Portions 20b which extend to the right and the left from the middle portion 20a respectively constitute the both-side walls 202, 402 of the first and second tube-shaped frames 2, 4. Free ends of the portions 20b end at bending end portions 20c which bend at a right angle. The both-side bending end portions 20c constitute the upper end walls 204b, 404b of the first and second tube-shaped frames 2, 4.

The plate member 20 which has been formed in the shape as described above is in advance prepared, and then the middle portion 20a is pressed downward with a specified jig so as to become flat. Thereby, the both-side portions 20b are changed so as to rise upward in the direction shown by an arrow, so that the end faces of the both-side bending end portions 20c face to each other. These bending end portions 20c are made butt at each other, and then these butting portions are jointed to each other by the one-side continuous welding, such as wire lazar welding, thereby forming a tube-shaped frame 30 (FIG. 4). This tube-shaped frame 30 has a closed cross section, like the hollow member which is formed by the hydro-forming In FIG. 4, a reference numeral 10 denotes the lazar welding portion.

While the closed cross section structure in the conventional monocoque body is formed by the spot welding of the flange portions, the above-described hollow member is formed by the continuous welding without any flanges welded. Accordingly, the tube-shaped frame 30 may be called as a “frame with no flange to form a frame.”

First Modification of Tube-Shaped Frame (FIG. 5)

A tube-shaped frame 34 as a first modification (FIG. 5) includes the second bending portions 20d which further bend at butting end portions of the both-side bending portions 20c respectively. These second bending portions 20d face to each other inside a closed cross section 32. Herein, the second bending portions 20d may be arranged outside the tube-shaped frame 34. In this case, the base end portions of the second bending portions 20d which are overlapped can be joined by the continuous welding.

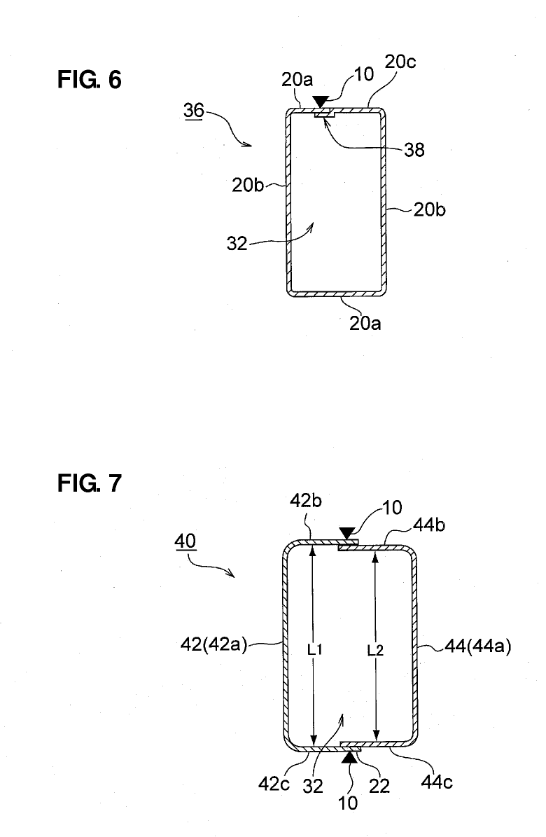

Second Modification of Tube-Shaped Frame (FIG. 6)

A tube-shaped frame 36 as a second modification (FIG. 6) includes a step portion 38 at one of the first bending portions 20c. The other of the first bending portions 20c is received at this step portion 38, so that the other of the first bending portion 20c and the step portion 38 of the one of the first bending portions 20c are overlapped and these overlapped portions are joined by the lazar welding, for example.

Third Modification of Tube-Shaped Frame (FIG. 7)

A tube-shaped frame 36 as a third modification (FIG. 7) comprises split-frames 42, 44 which have a U-shaped cross section. These frames 42, 44 are joined by the lazar welding at their overlapped portions. Thus, these first and second split-frames 42, 44 have the U-shaped cross sections which include two end portions 42b, 42c, 44b, 44c which bend from the both ends of their central portions 42a, 44a. The distance L1 between the end portions 42b, 42c of the first split-frame 42 is slightly longer than the distance L2 between the end portions 44b, 44c of the second split-frame 44 (L1>L2). Part of the end portions 42b, 42c of the first split-frame 42 and part of the end portions 44b, 44c of the second split-frame 44 are overlapped vertically.

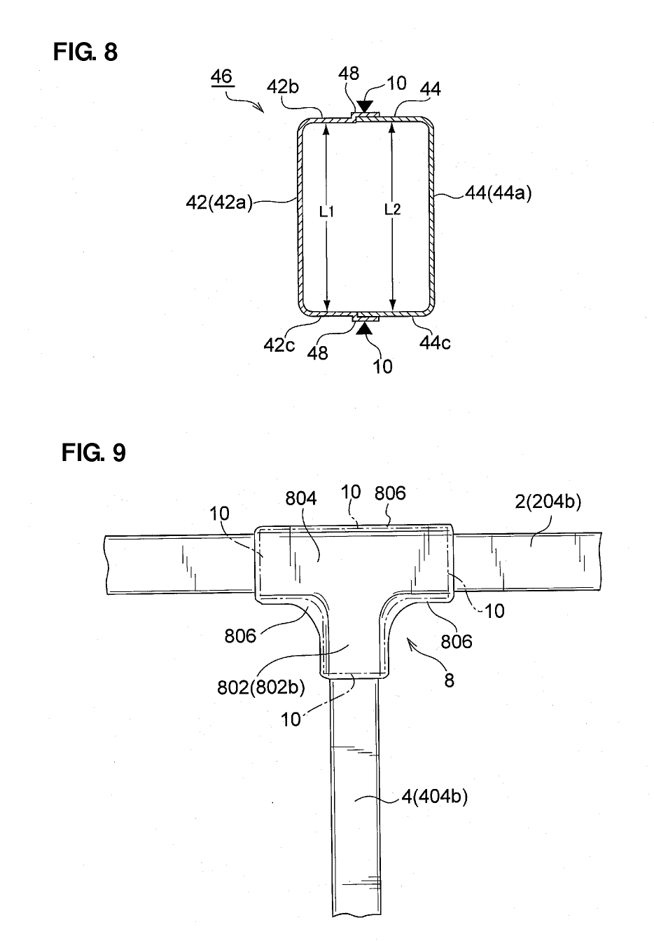

Fourth Modification of Tube-Shaped Frame (FIG. 8)

FIG. 8 shows a modification 46 of the tube-shaped frame 4 of FIG. 7. According to the tube-shaped frame 46 of FIG. 8, the distance L1 between the end portions 42b, 42c of the first split-frame 42 is equal to the distance L2 between the end portions 44b, 44c of the second split-frame 44 (L1=L2). The end portions 42b, 42c of the first split-frame 42 include step portions 48, respectively, and the ends of the second split-frame 44 are received at these step portions 48. Thus, part of the end portions 42b, 42c of the first split-frame 42 and part of the end portions 44b, 44c of the second split-frame 44 are overlapped vertically.

Modification of Connection Structure of First Embodiment (FIGS. 9-11)

While the first flanges 604, 806 of the first and second spilt-brackets 6, 8 are joined to the lower end wall 204a and the upper end wall 404a by the continuous welding in the above-described first embodiment (FIGS. 1 and 2), according to the connection structure of the present modification (FIGS. 9-11), split enclosing portions 608, 808 which enclose the first tube-shaped frame 2 are provided at the first and second split-brackets 6, 8, and flanges 608a, 808a are provided along split lines of the split enclosing portions 608, 808. The flanges 608a, 808a are overlapped and joined to each other by the continuous welding. Herein, of course, the overlapped flanges 608a, 808a may be joined by spot welding in the first step, and then they may be joined by the one-side continuous welding such as the lazar welding as the second step.

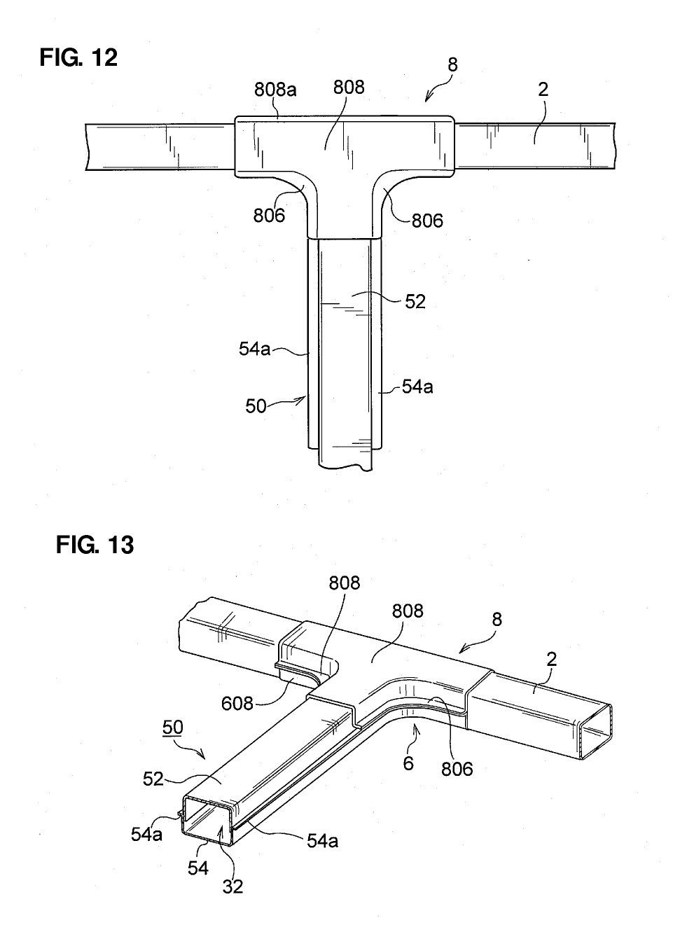

Second Embodiment of Connection Structure (FIGS. 12-14)

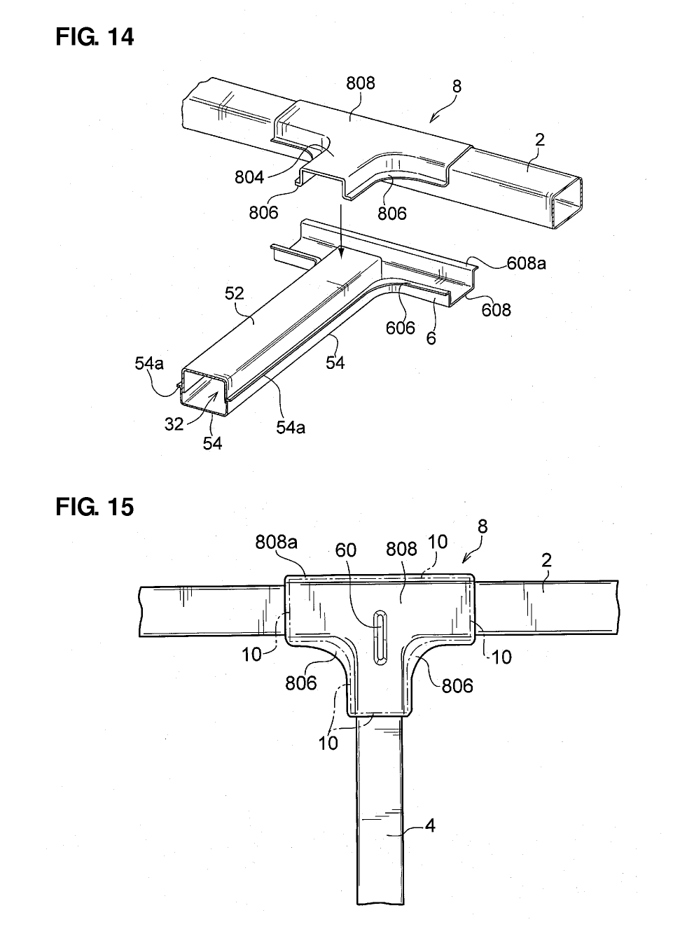

According to the connection structure of the second embodiment, a second tube-shaped frame 50 which connects to the side wall of the first tube-shaped frame 2 is comprised of two split-frames 52, 54 which have the U-shaped cross section as shown in FIGS. 7 and 8. The lower split-frame 54 has a pair of flanges 54a which project outwardly. Herein, the above-described first split-bracket 6 is formed integrally with this lower split-frame 54, which is apparent from FIG. 14. Herein, of course, the lower first split-bracket 6 which is formed integrally with the lower split-frame 54 may be the embodiment of FIG. 1.

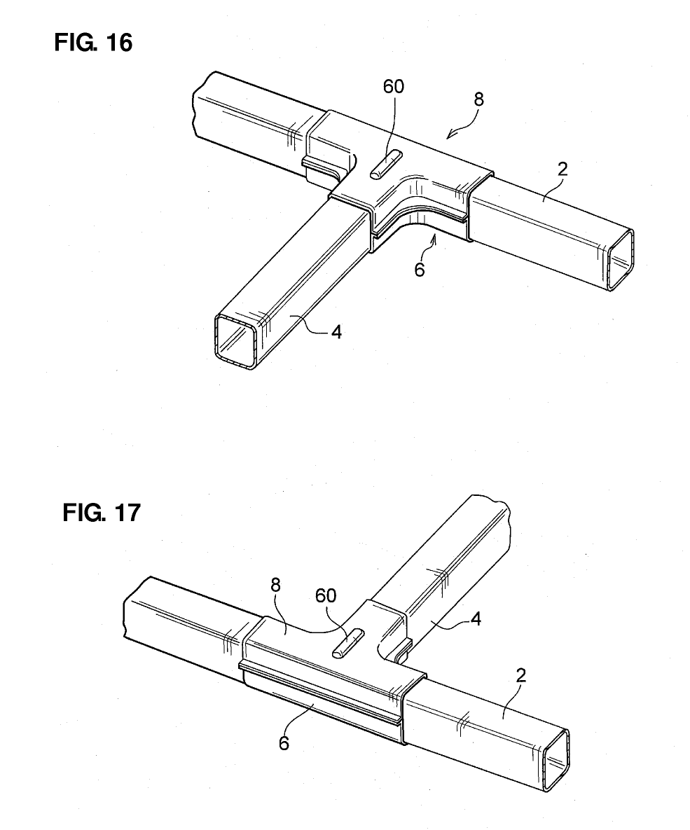

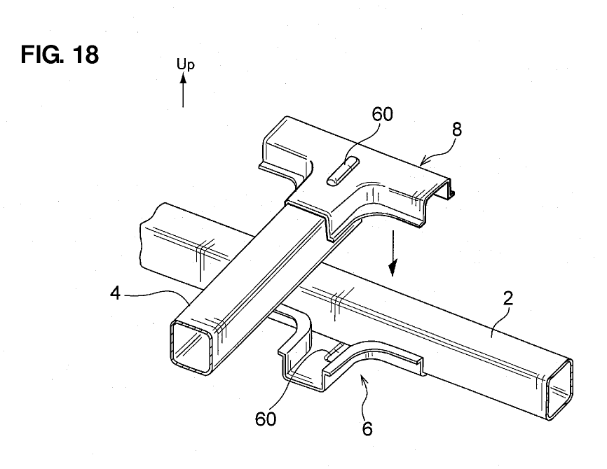

Third Embodiment of Connection Structure (FIGS. 15-18)

FIGS. 15-18 show another embodiment, a third embodiment, in which a protruding portion 60 is provided at each of the borders between the bracket bodies 602, 802 and the enclosing portions 608, 808 of the first and second split-brackets 6, 8. The third embodiment shown here is based on the split-brackets 6, 8 of the above-described modification of the first embodiment (FIGS. 9-11). However, the feature of the third embodiment may be applied to the above-described first embodiment (FIG. 1) or the second embodiment (FIGS. 12-14) as well.

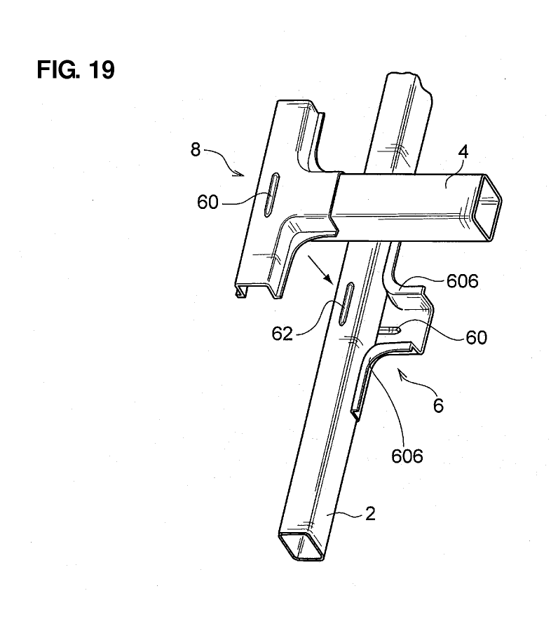

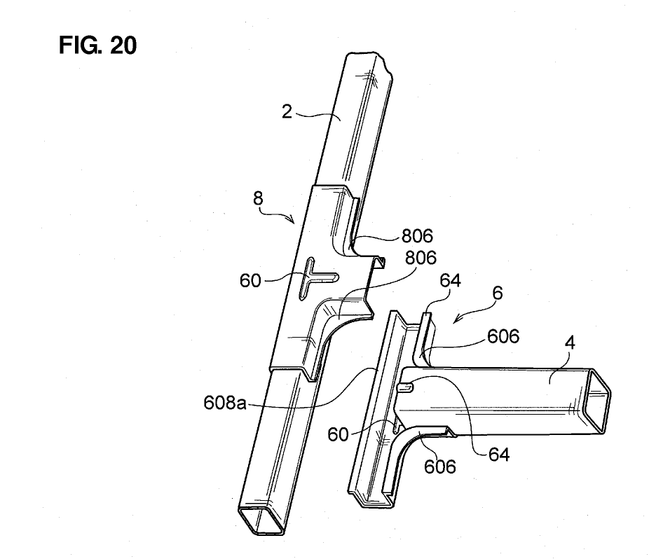

Modification of Third Embodiment (FIGS. 19 and 20)

The protruding portions 60 of FIGS. 15-18 of the third embodiment may be configured to extend in the split enclosing portions 608, 808 of the split-brackets 6, 8 in an extending direction of the first tube-shaped frame 2. Further, second protruding portions 62 may be provided at the upper end wall 204b and the lower end wall 204a of the first tube-shaped frame 2 so as to correspond to the protruding portions 60 (FIG. 19). Moreover, as another modification, as shown in FIG. 20, the first protruding portions 60 of the split-brackets 6, 8 may be formed in a T shape so as to extend in both extending directions of the first tube-shaped frame 2 and the second tube-shaped frame 4. Herein, a third protruding portion 64 which extends in the extending direction of the second tube-shaped frame 4 may be further provided at each of end portions of the upper end wall 404b and the lower end wall 404a of the end portion of the second tube-shaped frame 4 (FIG. 20). Herein, FIG. 19 shows an example in which the straight protruding portion 60 which extends in the extending direction of the first tube-shaped frame 2 is formed at the upper second split-bracket 8, the T-shaped protruding portion 60 is formed at the lower first split-bracket 6, and the third protruding portion 64 is formed at the end portion of the lower end wall 404a of the second tube-shaped frame 4.

The positions and shapes (concave and convex) of the above-described protruding portions 60, 62, 64 may be set so that the respective flanges of the first and second tube-shaped frames 2, 4 which are to be joined by welding can located at their proper positions by moving these frames 2, 4 when these frames 2, 4 are assembled (the third step described above).

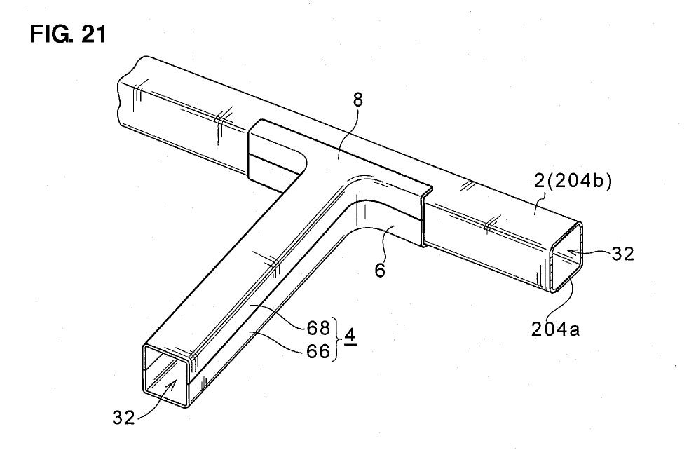

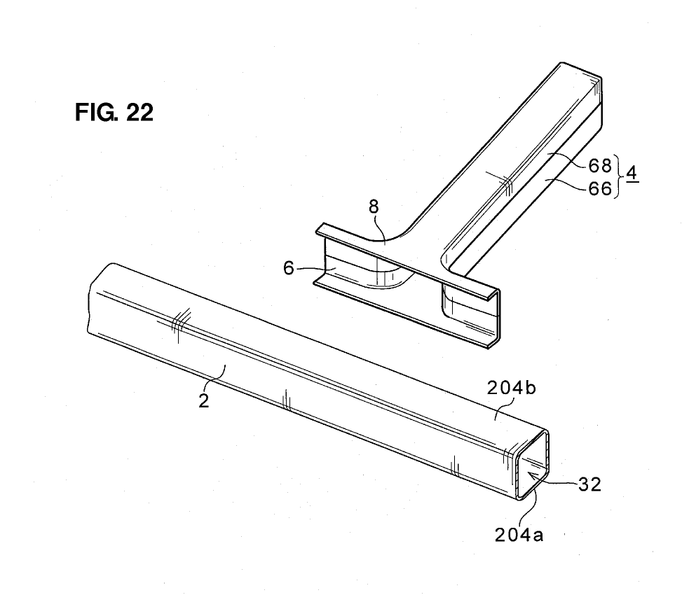

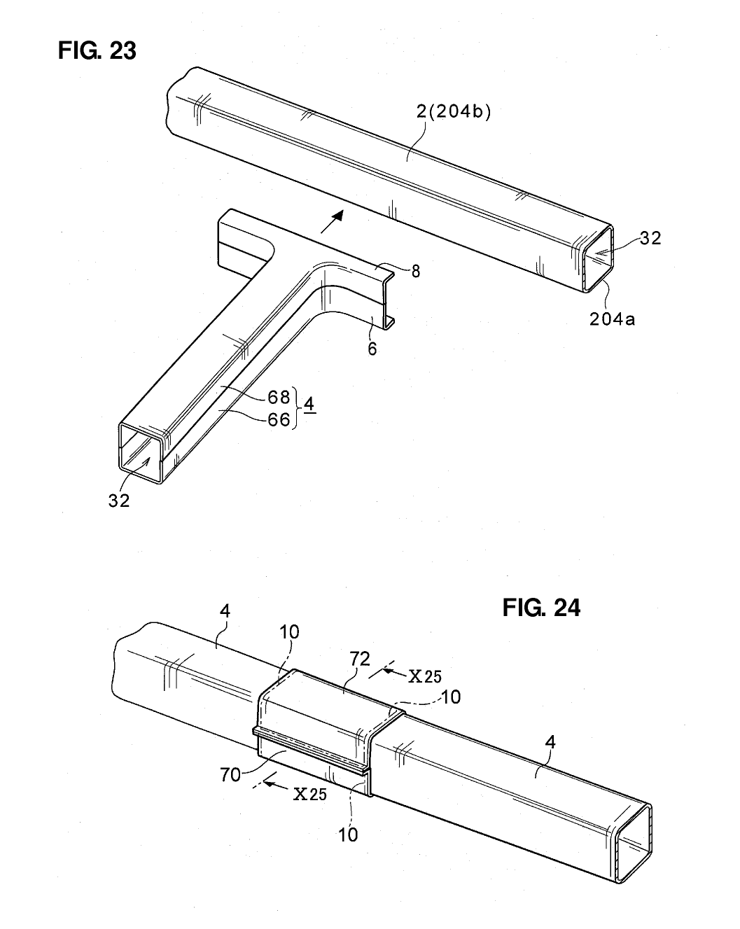

Fourth Embodiment of Connection Structure (FIGS. 21-23)

According to a fourth embodiment, the second tube-shaped frame 4 is comprised of a pair of split-frames 66, 68, and the above-described first and second split-brackets 6, 8 are formed integrally with these split-frames 66, 68. In the fourth embodiment, the first and second split-brackets 6, 8 preferably include the second flanges 604, 804 which contact the end walls 204a, 204b of the first tube-shaped frame 2 shown in FIG. 1. Herein, while the second tube-shaped frame 4 is formed by applying the continuous welding along the split line of the split-frames 66, 68 in this illustrated example, the flange joining of the split-frames 66, 68 may be applied. In this case, of course, it is preferable that the first and second split-brackets 6, 8 have the flanges 606, 806 as well.

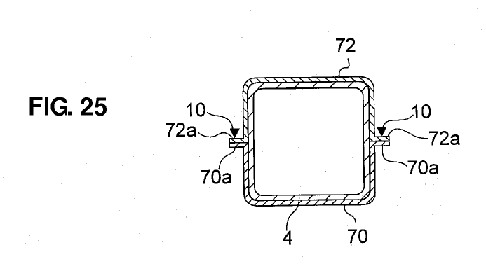

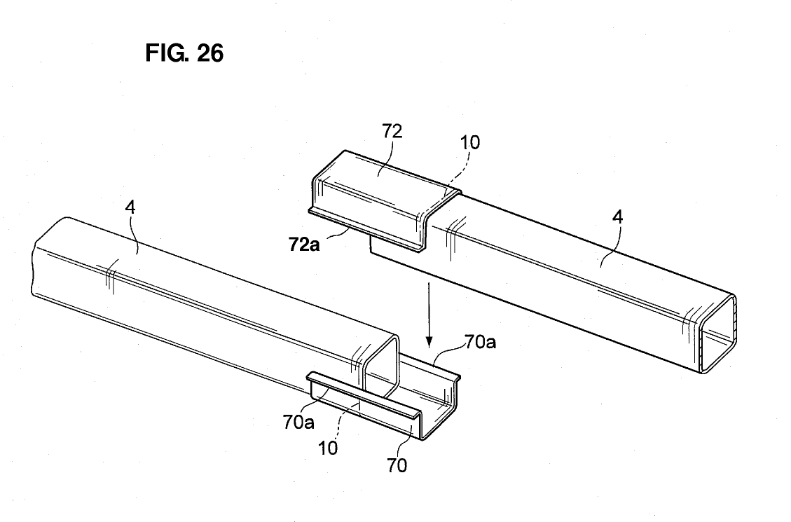

Fifth Embodiment of Connection Structure (FIGS. 24-26)

A fifth embodiment is an embodiment in which respective ends of the tube-shaped frames 4, 4 which are arranged in series are connected. First and second split-brackets 70, 72 which have a U-shaped cross section are provided so as to be positioned over the facing ends of the two tube-shaped frames 4, 4, and these split-brackets 70, 72 are disposed so that their flanges 70a, 72a which extend along their split line are overlapped. These flanges 70a, 72a are joined by the continuous welding with the lazar welding. The two tube-shaped frames 4, 4 which are arranged in series are joined to each other by welding the edges of the first and second split-brackets 70, 72. The continuous welding line is denoted by the reference numeral 10.

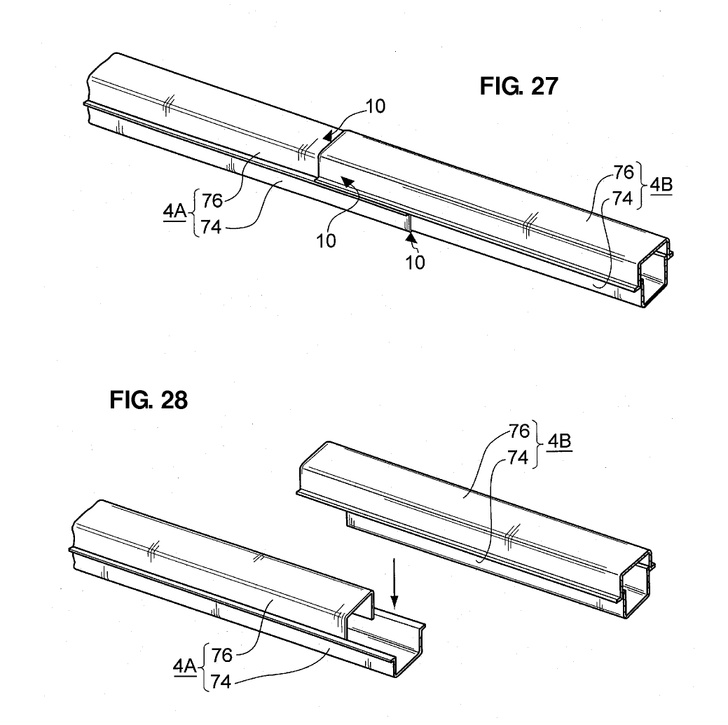

Modification of Fifth Embodiment (FIGS. 27 and 28)

FIGS. 27 and 28 show a modification of the above-described fifth embodiment (FIGS. 15-18), in which two tube-shaped frames 4A, 4B which are connected in series comprise two split-frames 74, 76, respectively. In the left-side tube-shaped frame 4A, the lower split-frame 74 is longer than the upper split-frame 76. In the right-side tube-shaped frame 4B, the upper split-frame 76 is longer than the lower split-frame 74. Respective contacting portions of the tube-shaped frames 4A, 4B are joined by the continuous welding with the lazar welding.

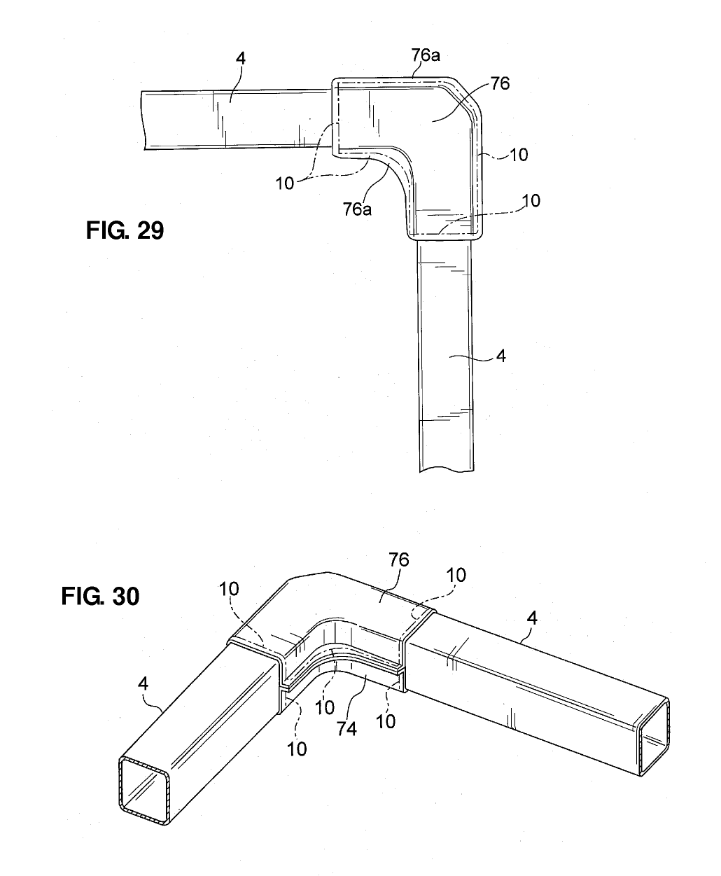

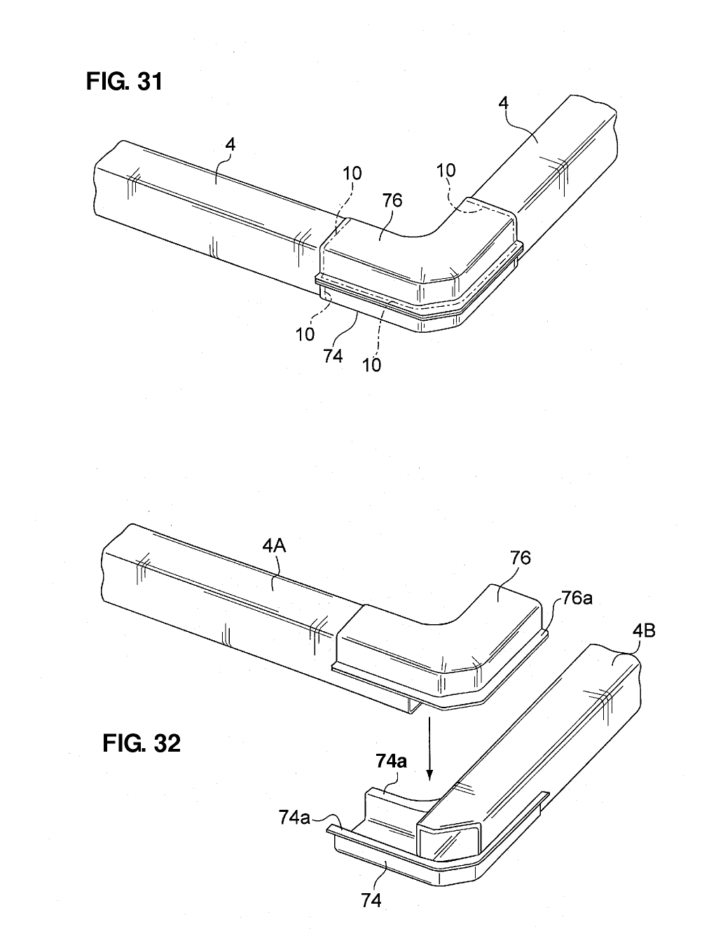

Sixth Embodiment of Connection Structure (FIGS. 29-32)

A sixth embodiment is an embodiment in which the tube-shaped frames 4, 4 are connected to each other in the L shape. First and second split-brackets 74, 76 which have a U-shaped cross section have an L shape in the plan view. As apparent from FIG. 32, the end face of the first tube-shaped frame 4 (4A) is disposed so as to contact the side wall of the second tube-shaped frame 4 (4B) (FIG. 32). The both end portions of the first and second split-brackets 4, 4 which face to each other are enclosed by the first and second split-brackets 74, 76, and flanges 74a, 76a of the first and second split-brackets 74, 76 and the end portions of these split-brackets 74, 76 are joined by the continues welding with the lazar welding. Thereby, the first and second tube-shaped frames 4, 4 are joined in the L shape. The substantial length of the first and second tube-shaped frames 4, 4 can be properly controlled by adjusting the gap formed between these frames 4, 4.

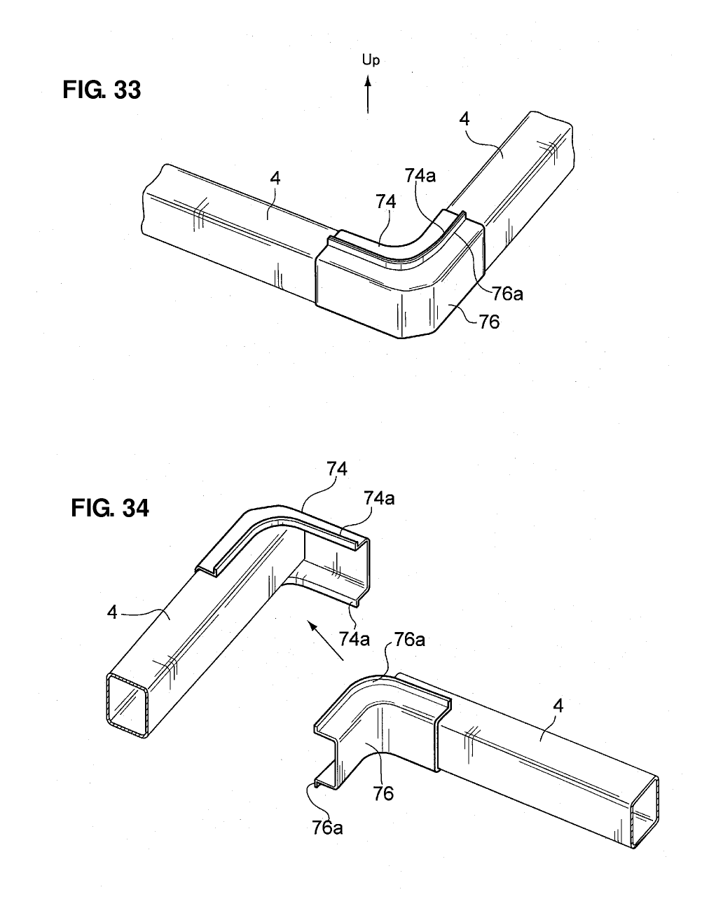

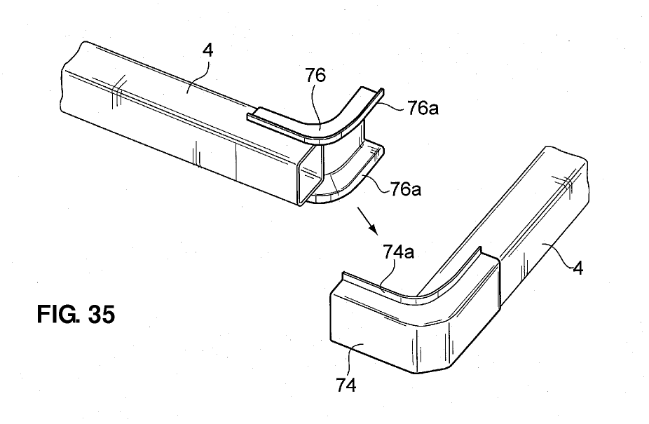

Modification of Sixth Embodiment (FIGS. 33-35)

While the first and second split-brackets 74, 76 are arranged vertically in the above-described sixth embodiment, they may be arranged laterally as shown in FIGS. 33-35.

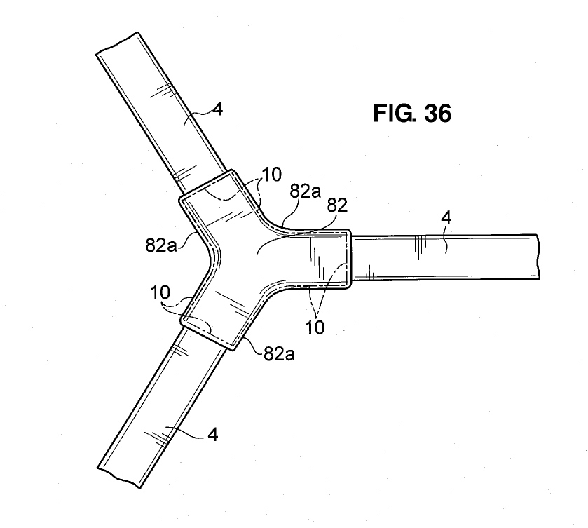

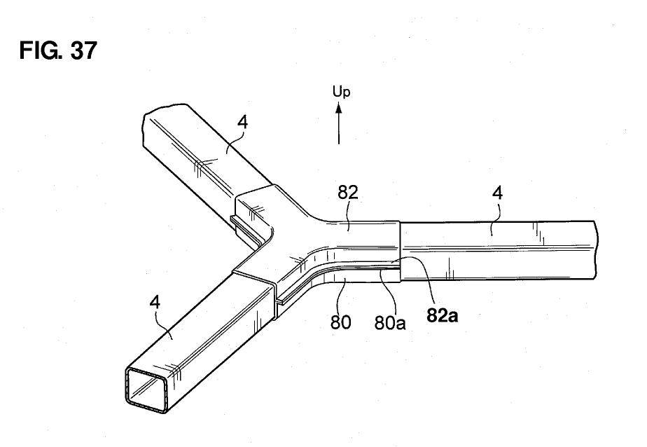

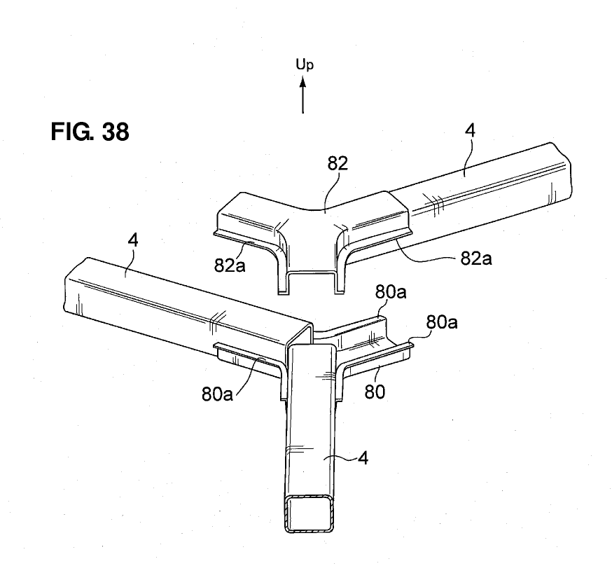

Seventh Embodiment of Connection Structure (FIGS. 36-38)

A seventh embodiment is an embodiment in which the three tube-shaped frames 4, 4 are connected in a Y shape in the plan view. In the seventh embodiment, upper and lower split-brackets 80, 82, which have the Y shape in the plan view, are arranged so as to enclose the end portions of the three tube-shaped frames 4. Flanges 80a, 80b of these split-brackets 80, 82 which extend along the split line of these brackets 80, 82 are overlapped and joined by the continuous welding. Thereby, the three tube-shaped frames 4 can be joined in the Y shape.

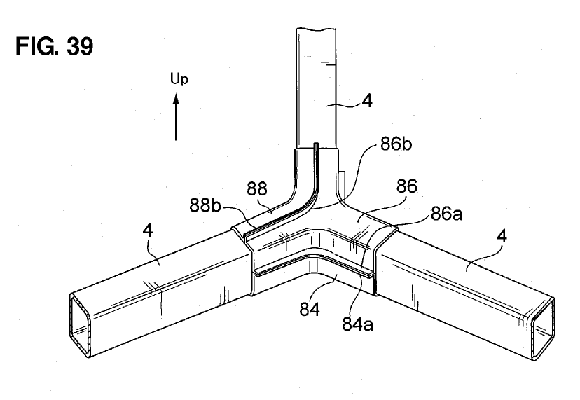

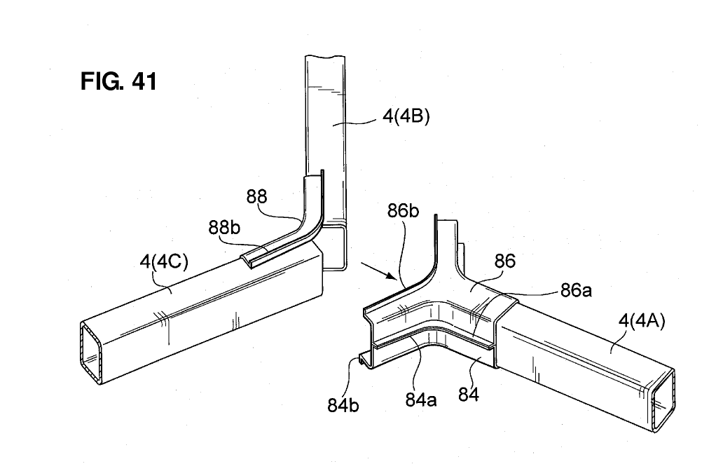

Modification of Seventh Embodiment (FIGS. 39-41)

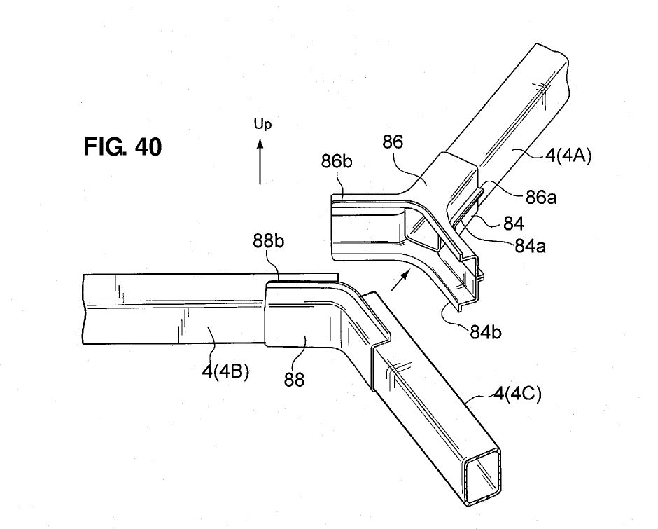

While the Y-shaped split-brackets 80, 82 are configured to be arranged vertically above and below the connection portion of the three tube-shaped frames 4 in the above-described seventh embodiment, another example comprising three split-brackets 84, 86, 88 will be described as a modification of the seventh embodiment. Herein, first and second split-brackets 84, 86 which have a Y shape in the plan view are arranged vertically at the connection portion of the three tube-shaped frames 4, and these first and second split-brackets 84, 86 and a third bracket 88 are arranged laterally side by side. According to the modification, the first and second split-brackets 84, 86 are joined to a tube-shaped frame 4A by the continuous welding and the third split-bracket 88 is joined to another tube-shaped frame 4B by the continuous welding in advance. Or, the third split-bracket 88 may be preferably joined to the other tube-shaped frame 4C in advance (FIG. 40). Then, in the vehicle assembly line, the two tube-shaped frames 4, 4 which are joined to each other via the third split-bracket 88 are assembled to the first and second split-brackets 84, 86 so that vertical flanges 84b, 86b, 86b are overlapped. These overlapped flanges are spot-welded for temporary assembling. Finally, the flanges 84b, 86b, 86b are joined to each other by the continuous welding with the lazar welding, so that the three tube-shaped frames 4 can be joined in the Y shape.

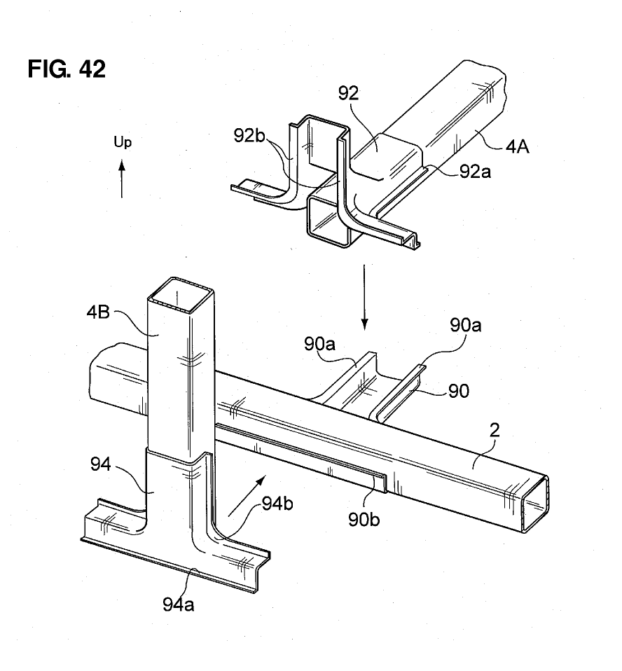

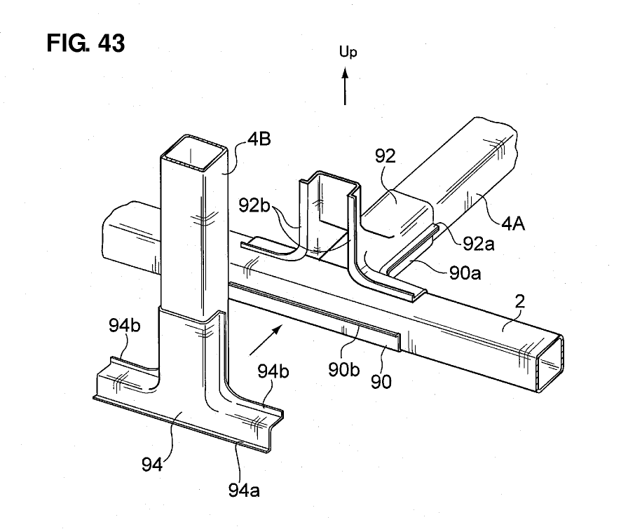

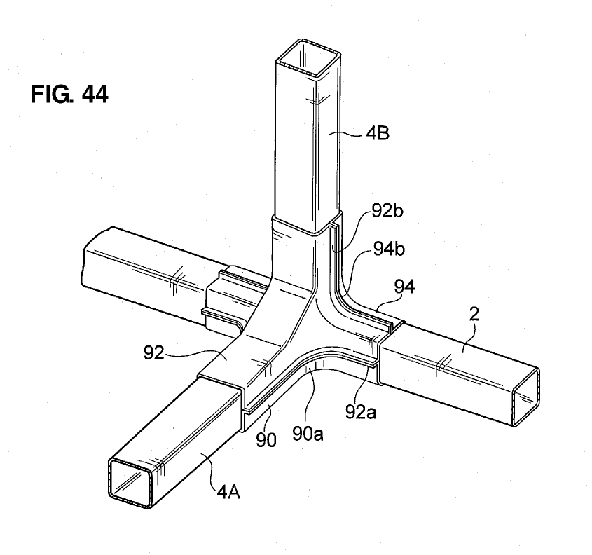

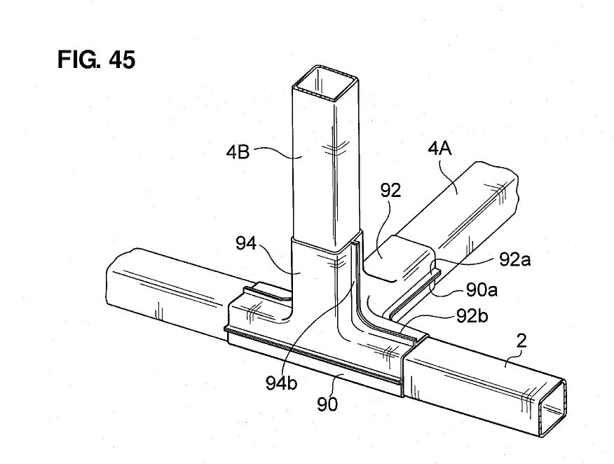

Eighth Embodiment of Connection Structure (FIGS. 42-45)

In an eighth embodiment, the second tube-shaped frame 4A is connected to the side wall 202 of the first tube-shaped frame 2, and the third tube-shaped frame 4B is connected to the end wall 204, so that the connection portion of the three tube-shaped frames 2, 4, 4 are formed as a solid structure. Three split-brackets 90, 92, 94 are provided in this eighth embodiment.

A first split-bracket 90, which has the T shape in the plan view of the first tube-shaped frame, has a structure which corresponds to the first tube-shaped frame 2 and a lower portion of the second tube-shaped frame 4A which is connected to the first tube-shaped frame 2 in the T shape in the horizontal face. A second split-bracket 92 has a structure which covers half of the upper portion of the first tube-shaped frame 2, the upper portion of the second tube-shaped frame 4A, and half of the third tube-shaped frame 4B which rises from the first tube-shaped frame 2. A third split-bracket 94 has a structure which covers partially the first tube-shaped bracket 2 and the third tube-shaped frame 4B. The connection structure of the first, second and third tube-shaped frames 2, 4A, 4B is formed by the first, second and third split-brackets 90, 92, 94 which are assembled together.

According to the eighth embodiment, the first split-bracket 90 is joined to the first tube-shaped frame 2 by the continuous welding, the second split-bracket 92 is joined to the second tube-shaped frame 4A by the continuous welding, and the third split-bracket 94 is joined to the third tube-shaped frame 4B by the continuous welding in advance. Then, in the vehicle assembly line, these three split-brackets 90, 92, 94 are assembled together so that flanges 90a, 92a are overlapped, flanges 90b, 94a are overlapped, and flanges 92b, 94b are overlapped, respectively. These overlapped flanges are spot-welded for temporary assembling. Finally, these flanges are joined to each other by the continuous welding with the lazar welding, so that the three tube-shaped frames 2, 4A, 4B can be joined as the solid structure. Herein, the above-described spot-welding may be omitted as described before.

Any type of non-iron-based fillers, such as foaming resin, may be filled into the connection portion of the tube-shaped frames 2, 4 or 4, 4 in the above-described embodiments. Thereby, the connection strength can be increased. Since the flanges 606, 806 of the split-brackets 6, 8 are provided so as to face to each other and these flanges 606, 806 are joined in the above-described first embodiment or others, the gaps between the frames 2, 4 can be controlled properly by adjusting the relative positions of the flanges 606, 806.

Further, while the split-brackets 6, 8 are joined via the flanges 606, 806 in the first embodiment or others, these flanges may be omitted and respective ends of the side walls 602a, 802a of the split-brackets may be joined by the continuous welding with lazar welding instead.

Moreover, while the above-described embodiments show the examples in which the split brackets (6, 8 . . . ) or the split frames (52, 54 . . . ) are comprised of a pair of split members which is arranged in the vertical direction of the vehicle, the present invention is applicable to any other structure in which these members are arranged in another specified direction, such as the lateral direction or the longitudinal direction of the vehicle.

The present invention should not be limited to the above-descried embodiments and their modifications, and any other improvements may be applied within the scope of a spirit of the present invention.

What is claimed is:

1. A connection structure of tube-shaped frames, comprising:
plural tube-shaped frames; and
plural split-brackets provided at a connection portion of said plural tube-shaped frames, each of the split-brackets having a shape for receiving part of the plural tube-shaped frames at said connection portion,
wherein said split-brackets are joined to each other at facing portions thereof by continuous welding, and each of the split-brackets is joined to one of the tube-shaped frames which is located adjacent thereto by one-side continuous welding.

2. The connection structure of tube-shaped frames of claim 1, wherein each of said split-brackets has a flange which extends outwardly along a split line of the facing portions of the split-brackets, and the flanges of the split-brackets which are overlapped are joined to each other by one-side continuous welding.

3. The connection structure of tube-shaped frames of claim 1, wherein said brackets comprise an upper split-bracket and a lower split-bracket, each of the upper split-bracket and the lower split-bracket has a flange which extends along a split line of the facing portions of the upper and lower split-brackets, and the flanges of the upper and lower split-brackets which are overlapped are joined to each other by one-side continuous welding.

4. The connection structure of tube-shaped frames of claim 3, wherein at least one of said tube-shaped frames comprises an upper split-frame and a lower split-frame which are split, the upper and lower split-frames are joined to each other along the split line by one-side continuous welding to form the tube-shaped frame, and the lower split-frame and said lower split-bracket are formed integrally.

5. The connection structure of tube-shaped frames of claim 3, wherein at least one of said tube-shaped frames comprises an upper split-frame and a lower split-frame which are split, the upper and lower split-frames are joined to each other along the split line by one-side continuous welding to form the tube-shaped frame, and the upper split-frame and said upper split-bracket are formed integrally and the lower split-frame and said lower split-bracket are formed integrally.

6. The connection structure of tube-shaped frames of claim 1, wherein said brackets comprise a pair of split-brackets which is arranged in a specified direction, each of the split-brackets has a flange which extends along a split line of the facing portions of the split-brackets, and the flanges of the split-brackets which are overlapped are joined to each other by one-side continuous welding.

7. The connection structure of tube-shaped frames of claim 6, wherein at least one of said tube-shaped frames comprises a pair of split-frames which are split in said specified direction, the split-frames are joined to each other along the split line by one-side continuous welding to form the tube-shaped frame, and one of the split-frames and one of the split-brackets are formed integrally.

8. The connection structure of tube-shaped frames of claim 6, wherein at least one of said tube-shaped frames comprises a pair of split-frames which are split in said specified direction, the split-frames are joined to each other along the split line by one-side continuous welding to form the tube-shaped frame, and one of the split-frames and one of the split-brackets are formed integrally and one of the split-frames and one of the split-brackets are formed integrally.

9. An assembly method of tube-shaped frames, in which the tube-shaped frames comprise a pair of roof side frames which are provided at both sides of a vehicle body and a roof cross member which extends perpendicularly to the roof side frames so as to connect to the roof side frames at both ends thereof, the assembly method comprising:
a step of providing brackets for connecting the both ends of the roof cross member to the roof side frames, the brackets comprising an upper split-bracket and a lower split-bracket, each of the upper split-bracket and the lower split-bracket having a flange which extends along a split line of the upper and lower split-brackets;
a first step of joining the lower split-bracket to a lower portion of the roof side frame by one-side continuous welding;
a second step of joining the upper split-bracket to an upper portion of the end of the roof cross member by one-side continuous welding;
a third step of assembling the upper split-bracket joined to the roof cross member to the lower split-bracket joined to the roof side frame;
a fourth step of joining the flanges of the upper and lower split-brackets which are overlapped by temporary welding; and
a fifth step of joining said flanges joined by the temporary welding by one-side continuous welding.

10. An assembly method of tube-shaped frames, in which the tube-shaped frames comprise a pair of roof side frames which are provided at both sides of a vehicle body and a roof cross member which extends perpendicularly to the roof side frames so as to connect to the roof side frames at both ends thereof, the assembly method comprising:
a step of providing brackets for connecting the both ends of the roof cross member to the roof side frames, the brackets comprising a pair of split-brackets which is arranged in a specified direction, each of the split-brackets having a flange which extends along a split line of the split-brackets;
a first step of joining one of the split-brackets to a portion of the roof side frame by one-side continuous welding;
a second step of joining the other of the split-brackets to another portion of the end of the roof cross member by one-side continuous welding;
a third step of assembling the other of the split-brackets joined to the roof cross member to the one of the split-brackets joined to the roof side frame;
a fourth step of joining the flanges of the split-brackets which are overlapped by temporary welding; and
a fifth step of joining said flanges joined by the temporary welding by one-side continuous welding.
